(19) United States
(12) Patent Application Publication
(10) Pub. No.: US 2012/0236105 A1
(43) Pub. Date: Sep. 20, 2012

(54) METHOD AND APPARATUS FOR MORPHING A USER DURING A VIDEO CALL

(75) Inventors: William P. Alberth, Prairie Grove, IL (US); Dean E. Thorson, Grayslake, IL (US); Kenneth A. Haas, Sleepy Hollow, IL (US)

(73) Assignee: MOTOROLA MOBILITY, INC., Libertyville, IL (US)

(21) Appl. No.: 13/047,072

(22) Filed: Mar. 14, 2011

(51) Int. Cl. H04N 7/14; G09G 5/00

(52) U.S. Cl. 348/14.07; 345/646; 348/E07.078

(57) ABSTRACT

A method and apparatus for changing an appearance of a user during a video call is provided herein. Prior to making a call, a user identifies several images that can be used as morphing templates and also identifies a context where each template will be used. During a video call, a morphing template is then chosen based on a context of the call (e.g., time, place, caller identification, etc.). During the video call, the user's image will be morphed based on the chosen template. Because templates used for morphing will be easily changed based on a context of the call, the user will be provided with a simple technique to for morphing their image.

### FIELD OF THE INVENTION

The present invention relates generally to video calling and in particular, to a method and apparatus for morphing a user during a video call.

### BACKGROUND OF THE INVENTION

With the increasing availability of on-line communication applications and broadband internet access, communicating with friends and family using real-time audio and video is becoming more and more popular. Unlike audio-only communication, where the appearance of the participant, or the participant's environment, is not at all important, the participant in a video conference often makes a great effort to look his or her best prior to commencing it. For example, women may feel compelled to apply make-up before appearing on camera, just as they would before going out for any other social activities.

Many techniques exist for morphing a user during a video call. For example, US Pub. No. 2006/0268101, SYSTEM AND METHOD FOR APPLYING DIGITAL MAKE-UP IN VIDEO CONFERENCING, incorporated by reference herein, describes digitally changing an appearance of a caller. In a similar manner, US Pub. No. 2007/0242066 VIRTUAL VIDEO CAMERA DEVICE WITH THREE-DIMENSIONAL TRACKING AND VIRTUAL OBJECT describes dynamically inserting rendered 3-D objects (e.g., eyeglasses) within the video stream on a real-time basis. With ever-increasing processor power, and with the availability of cloud computing, this technology will become a more and more common feature of video calls.

A problem exists, however, in providing a user a simple technique to choose how to morph their image. With an infinite number of possible changes to a user's image, it may be very difficult for a user to choose how they appear in a video call. Additionally, in order to enhance the user experience, a simple technique for changing appearances may be desired. For example, a user may wish to appear differently, depending upon who they are talking to. More particularly, it would be beneficial to a user if they had a simple technique to choose how to morph their image. Therefore a need exists for a method and apparatus for morphing a user during a video call that allows a user to easily choose how they are morphed, and to easily change from one type of morphing to another type.

### BRIEF DESCRIPTION OF THE DRAWINGS

FIG. 1. is a block digraph of a video-calling system in accordance with a first embodiment.

FIG. 2. is a block diagram of a video-calling system in accordance with a second embodiment.

FIG. 3. is a flow chart showing operation of the video-calling system of FIG. 1 and FIG. 2.

FIG. 4 is a flow chart showing operation of the video-calling system of FIG. 1 and FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instructions executing either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to alleviate the above-mentioned need, a method and apparatus for changing an appearance of a user during a video call is provided herein. Prior to making a call, a user identifies several images or techniques that can be used as morphing templates and also identifies a context where each template/technique will be used. During a video call, a morphing template/technique is then chosen based on a context of the call (e.g., time, place, caller identification, etc.). During the video call, the user's image will be morphed based on the chosen template or technique. Because templates or techniques used for morphing will be easily changed based on a context of the call, the user will be provided with a simple method and apparatus to for morphing their image.

The present invention encompasses a method for morphing a user during a video call. The method comprises the steps of determining a context, determining a morphing technique based on the context, and morphing the user based on the context and the morphing technique.

The present invention additionally encompasses a method comprising the steps of receiving an image from a user, receiving from the user, a context for the image, and storing the image and the associated context.

The present invention additionally encompasses an apparatus comprising context aware circuitry determining a context, a processor determining a morphing technique based on the context and morphing the user based on the context and the morphing technique.

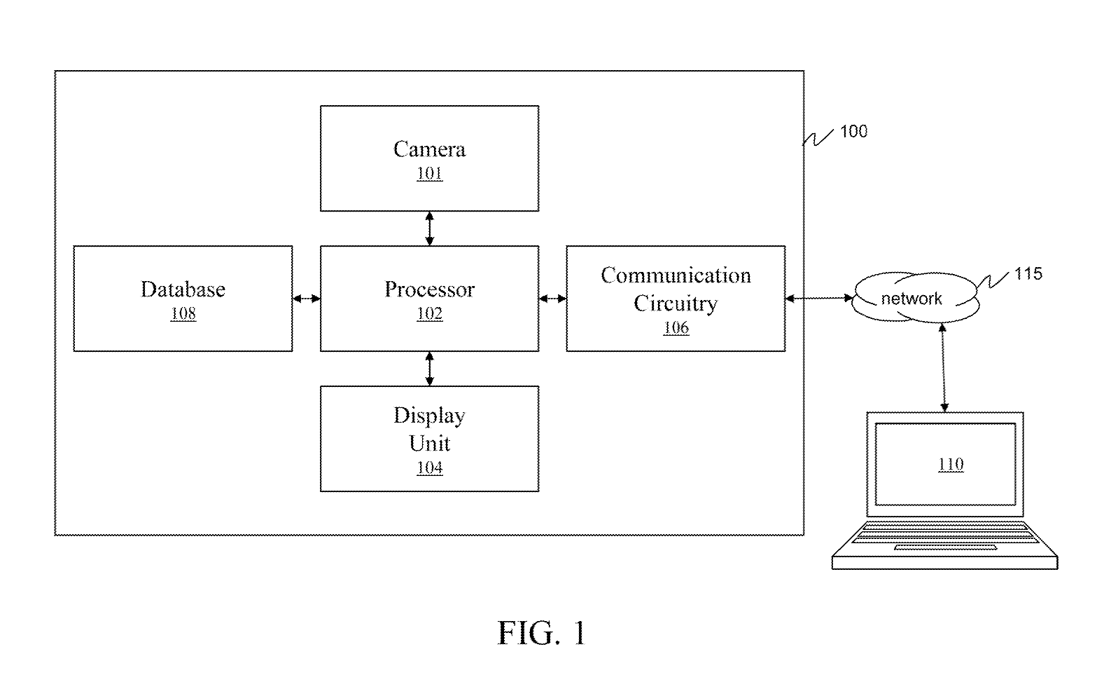

Turning now to the drawings, where like numerals designate like components, FIG. 1 is a block diagram showing a video-calling system in accordance with a first embodiment. System 100 is preferably implemented within a tablet computer such as a Motorola Xoom™ tablet, however, in alternate embodiments of the present invention, system 100 may be implemented within a desktop computer, a cellular telephone, a laptop computer, a handheld electronic device, or any other suitable device.

As shown system/device 100 includes camera 101, which may be a still camera or a video camera. Processor 102 preferably comprises an Nvidia Tegra 2 dual-core processor, and is configured to perform the necessary steps to appropriately morph a users image as described below. In this embodiment, processor 102 communicates with display 104 and communication circuit 106. Display 104 preferably comprises a 1280×800, 10.1 inch touch screen display. Display unit 104 also serves as a graphical user interface (GUI) used to receive input from a user. Communication circuit 106 comprises one or more of a network interface card, cellular modem, or Wi-Fi modem incorporating 802.11a/b/g/n. Communication circuitry 106 communicates to other network devices (e.g., device 110) through network 115. Finally, database 108 preferably comprises random access memory such as a Micro SD or on board flash storage space.

During operation of device 100, a user positions him or herself in front of camera 101. Camera 101 captures an image or video of the user and passes this image to processor 102. Processor 102 properly encodes the image/video and passes the image/video through network 115 to network device 110. Additionally, processor 102 may receive an image/video from network device 110 via circuitry 106. This image/video is sent to display unit 104 along with the user's captured image so that both the user and the image/video from device 110 can be displayed for viewing.

During a normal video call, a user of device 100 will have an ability to morph their image, sending the morphed image to device 110. Many techniques exist for morphing a user during a video call, and any technique may be utilized without varying from the scope of the present invention. However, a preferred technique for morphing an image of a user is described in U.S. Pat. No. 7,742,624, PERSPECTIVE IMPROVEMENT FOR IMAGE AND VIDEO APPLICATIONS, incorporated by reference herein. As described in the '624 patent, a user's image is morphed such that points in the image match corresponding points in one or more stored templates.

More particularly, processor 102 uses templates stored in database 108. The templates comprise several views of the user. An image is captured by camera 101 and a number of control points or features are identified in the captured image. The captured image is then warped or morphed to match each template. While the '624 patent only described the warping of a face, the present invention goes beyond simply warping the face to also modify the color of the skin, hairstyle, expression, and possibly the clothes worn based on a comparison with the template. In a particular embodiment, the clothes morphed onto the user may have a color that is chosen randomly so that the user does not look like they are wearing similar clothes every time they participate in a video call.

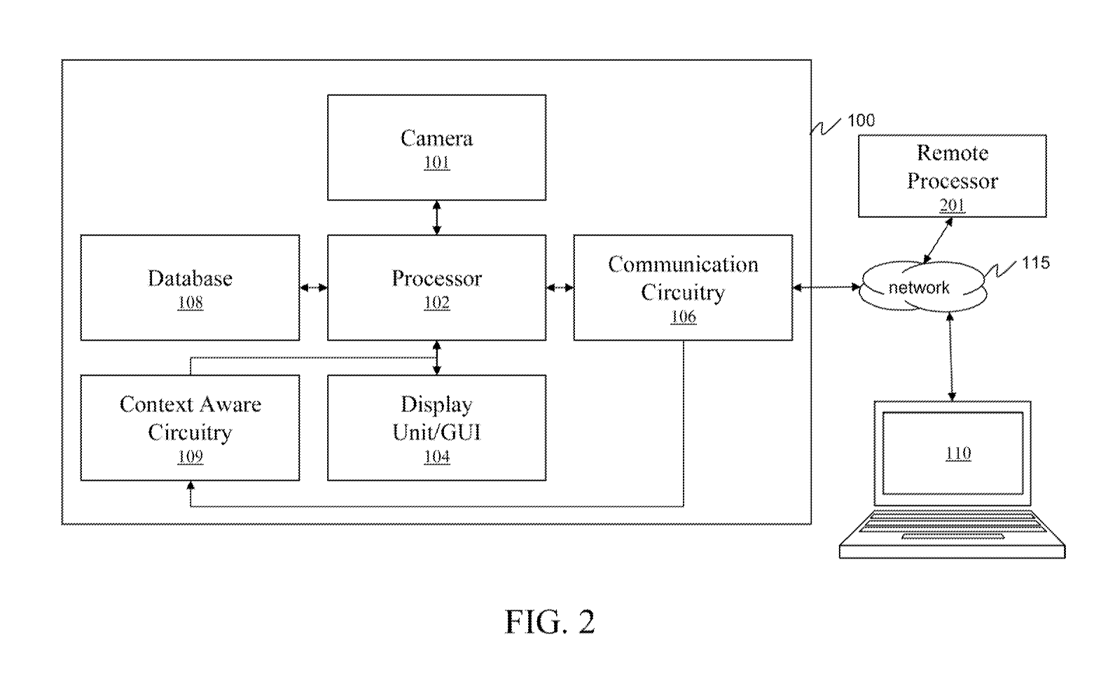

FIG. 2. is a block diagram of a video-calling system in accordance with a second embodiment. For this embodiment, all morphing takes place via “cloud computing”. More particularly, a template or technique and an image/video are sent to remote processor 201. Remote processor 201 performs the morphing operation and forwards the morphed image to device 110. In this manner, devices without the computing power to perform morphing will be able to accomplish this task remotely. Of course the morphing computation could be split between the device and the cloud.

As discussed above, a problem exists in providing a user a simple technique to choose how to morph their image. With an infinite number of possible changes to a user's image, it may be very difficult for a user to choose how they appear in a video call. Additionally, in order to enhance the user experience, a simple method and apparatus for changing appearances may be desired. For example, a user may wish to appear differently, depending upon who they are talking to. Therefore, it would be beneficial to a user if they had a simple technique to choose how to morph their image.

In order to address this issue, context aware circuitry 109 is provided. Context-aware circuitry 109 may comprise any device capable of generating a current context. For example, context-aware circuitry 109 may comprise a GPS receiver capable of determining a location of the user device. Alternatively, circuitry 105 may comprise such things as an electronic clock, an electronic calendar, environmental sensors (e.g. a thermometer capable of determining an ambient temperature, humidity, . . . , etc.), an accelerometer, a barometer, speech recognition circuitry, a user's electronic calendar, short-range communication circuitry (e.g., Bluetooth™ circuitry, zigbee, wifi, etc) to determine what other electronic devices are near, biosensors such as a heart-rate monitor, galvanic skin response, pulse, oxygen saturation, an activity and motion detector (accelerometer), activity impact (pressure sensors), a blood-pressure monitor, respiratory sensors, blood sugar monitor, or a hydration sensor.

During operation a user will identify several images that will be used as templates. For example, a user may identify an image of them in formal attire, casual attire, pajamas, with makeup, without makeup, winter clothing, summer clothing, images that they feel make them look professional, sultry, fun loving, serious, happy, tired, etc. The user will also determine a context for each image to be used as a morphing template. (As mentioned above, in an alternate embodiment, images of the user are not provided. The user simply identifies how they are to be morphed based on an associated context). For example, a user may wish for them to be morphed into formal attire when speaking to their boss. In a similar manner, a user may wish to be morphed into gym attire between certain hours of the day.

Processor 102 will retrieve a current context, and automatically choose an appropriate picture for the user. Some use cases are identified below:
Image template chosen based on time of day—The time of day may serve as a context, so that the image template chosen may be based upon the time of day. In this scenario context aware circuitry 109 comprises a clock. A user may wish to be morphed into work attire during work hours, or pajamas during late night hours regardless of actual attire being worn.
Image template chosen based on time of year—A date or time of year may be used as a context so that a user may be morphed into attire for the appropriate season. In this scenario context aware circuitry 109 comprises a calendar. A user may wish to avoid being morphed into summer attire during the winter.
Image template chosen based on location—A location may be used as a context. In this scenario context aware circuitry 109 comprise location circuitry such as Global Positioning System (GPS) circuitry that is used to determine a user's location. An appropriate image template may be chosen based on the location. For example, when a user is at work, more formal attire may be used for morphing.
Image template chosen based upon weather—A weather report (local weather information) may be used as a context. In this scenario context aware circuitry 109 comprises a standardized weather radio receiving a weather report (such as that generated by the National Oceanic and Atmospheric Association (NOAA)). An appropriate image template may be chosen based upon weather. For example, a user standing outside would want to appear to wear rain gear during a rain storm.
Image template chosen based on temperature—A temperature may be used as a context. In this scenario context aware circuitry 109 comprises a thermometer. An appropriate image template may be chosen based on temperature. For example, a user standing outside would not want to appear in summer attire during a snow storm.
Image template chosen based on speech-recognition circuitry—Who is speaking may be used as a context. In this scenario context aware circuitry 109 comprises speech recognition circuitry. An appropriate image template may be chosen based on who is speaking. For example, a male user may want to use a male template instead of a female template. Similarly, a particular user may want to use pictures of them self instead of others.
Image template chosen based on what other devices are near—In this scenario context aware circuitry 109 comprises a short-range receiver such as a Bluetooth™ receiver determining what devices are near. An appropriate image template may be chosen based on what other devices are near. For example, if the user's co-workers are near, it can be assumed that she is at work, and an image with more-formal attire may be used for morphing.
Image template based on caller identification—In this scenario context aware circuitry 109 comprises caller identification circuitry, such as an identification of a friend from a friend's list, or identification of an individual from a person's contact list. An appropriate image template may be chosen based on who a user is talking to. For example, an individual way wish to look professional when talking to their boss yet may choose to look casual when talking to a friend. In a similar manner a user can be morphed into attire, makeup, hairstyle, appropriate for a religious affiliation of the person communicated with. In a similar manner, caller identification can be used to determine the country of origin for the person who the user is talking with. The user will be morphed into attire, makeup, hairstyle, etc. that is appropriate for the country of origin of the person communicated with. For example, an individual may wish to have their head covered when talking to a person from Saudi Arabia, yet may look much more casual when talking to a person from the United Kingdom.
Image template based on emotion desired to display—In this scenario caller may be very sad but wishes to appear happy (if talking to a parent) or angry (if talking to a spouse). The users appearance would be morphed to an image that the user has preselected which depicts the desired emotion to portray.

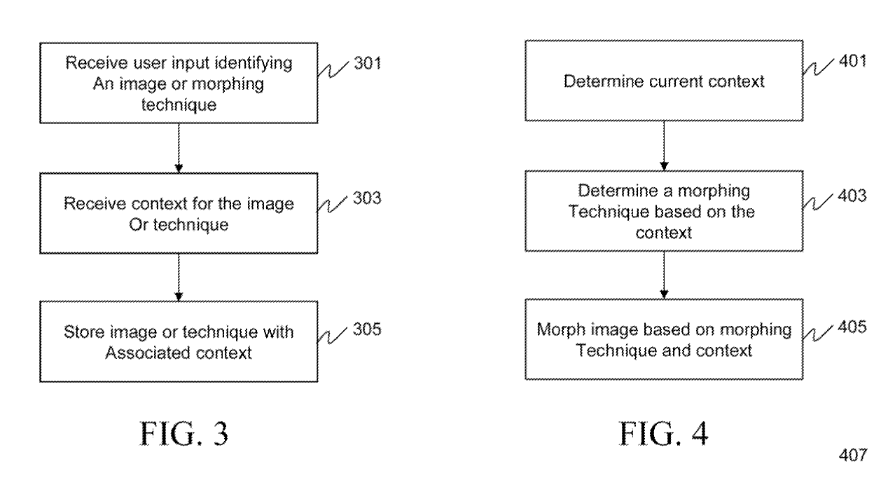

FIG. 3. is a flow chart showing operation of the video-calling system of FIG. 1 and FIG. 2. In particular, this flow chart shows steps taken by system 100 when storing images used for morphing a user. The logic flow begins at step 301 where processer receives a user input for GUI 104 that enters and identifies a particular image or morphing technique. At step 303 processor 102 receives an input from GUI identifying a context for the particular image or morphing technique. The logic flow continues to step 305 where processor 102 stores the particular image or technique along with an associated context within database 108. Once the image is stored along with the associated context, the user can then be morphed based on the image. In particular, when the user is placing a video call, the context can be determined and the image retrieved based on the context. The user can then be morphed based on the image.

FIG. 4 is a flow chart showing operation of the video-calling system of FIG. 1 and FIG. 2. In particular, this flow chart shows the steps taken by system 100 when morphing a caller. The logic flow begins at step 401 where processor 102 determines a current context from context-aware circuitry 109. This is accomplished by context aware circuitry 109 determining context and passing this information to processor 102. Context aware circuitry 109 may comprise one or more of the following:

a clock;

a calendar;

location circuitry

GPS circuitry;

a thermometer;

a radio;

caller identification circuitry;

speech recognition circuitry; and

short-range communication circuitry.

Using the above context-aware circuitry, the current context may then comprise one or more of the following:

a time of day;

a time of year;

a location;

a temperature;

localized weather information;

country of origin of caller;

who is speaking;

what devices are near; and

a caller identification.

Using the context, processor 102 then determines a morphing technique based on the context. In this particular embodiment, the morphing technique is determined by accesses database 108 and determining an appropriate image template associated with the context (e.g., an appropriate picture or the user) for morphing (step 403). As discussed above, the image template chosen is based on the current context. The logic flow then continues to step 405 where image morphing takes place based on the context and the morphing technique. In this particular embodiment the image or video received from camera 101 and the appropriate image template are utilized for morphing as described above. Processor 102 performs the morphing operation. In a second embodiment of the present invention the image template or morphing technique is sent to remote processor 201 along with the current image or video. The remote processor 201 then performs the morphing operation.

The morphing technique may comprise one or more of the following to change the appearance of the user or the user's background:

morphing clothes onto the user;

morphing a particular color of clothes onto the user;

morphing makeup onto the user;

morphing clothes for a particular season onto the user;

morphing a particular emotional state onto the user;

morphing the user into a particular background;

morphing a particular skin color onto the user; and

morphing a head cover onto the user.

While the invention has been particularly shown and described with reference to a particular embodiment, it will be understood by those skilled in the art that various changes in form and details may be made therein without departing from the spirit and scope of the invention. For example, while images of the user were used for morphing purposes, one of ordinary skill in the art will recognize that other morphing techniques may be used without varying from the scope of the invention as long as the morphing is associated with a context. For example, system 100 may simply determine a context, receiving an image or video of a user to be used in a video call. The context then can be associated with a morphing technique, and the image of the user then can be morphed based on the context and associated morphing technique. No image template may be necessary when morphing (See for example, US Pub. No. 2006/0268101). For example, a user may simply wish to be morphed into pajamas after a certain time of evening, or to have makeup placed on them self when a certain individual calls without providing an image of them in pajamas or makeup. It does not matter what techniques are used for morphing.

It should also be noted that multiple images and/or morphing techniques may be utilized simultaneously. For example, if the current context is “winter time” and “talking to boss”, a user may be morphed into formal winter attire.

Finally, while the above described morphing dealt particularly with a user's image, the same technique may be utilized to change the background of an image. For example, a user may wish to have their background appear as a workplace environment when a placing a work-related call. It is intended that such changes come within the scope of the following claims:

1. A method for morphing a user during a video call, the method comprising the steps of:
determining a context;
determining a morphing technique based on the context; and
morphing the user based on the context and the morphing technique.

2. The method of claim 1 wherein the step of determining the context comprises the step of determining one or more of:
a time of day;
a time of year;
a location;
a temperature;
localized weather information;
country of origin of caller;
who is speaking;
an emotion;
what devices are near; and
a caller identification.

3. The method of claim 1 wherein the step of determining a morphing technique comprises the step of determining an image template.

4. The method of claim 3 wherein the image template comprises a picture.

5. The method of claim 4 wherein the image comprises a picture of the user.

6. The method of claim 1 wherein the morphing technique comprises one or more of the following:
morphing clothes onto the user;
morphing a particular color of clothes onto the user;
morphing makeup onto the user;
morphing clothes for a particular season onto the user;
morphing a particular emotional state onto the user;
morphing the user into a particular background;
morphing a particular skin color onto the user; and
morphing a head cover onto the user.

7. The method of claim 1 wherein the step of morphing the user comprises the step of changing an appearance of the user.

8. The method of claim 1 wherein the step of morphing the user comprises the step of changing the user's background.

9. A method comprising the steps of:
receiving an image from a user;
receiving from the user, a context for the image; and
storing the image and the associated context.

10. The method of claim 9 further comprising the steps of:
determining a context;
retrieving the image based on the context; and
morphing the user based on the image.

11. An apparatus comprising:
context aware circuitry determining a context;
a processor determining a morphing technique based on the context and morphing the user based on the context and the morphing technique.

12. The apparatus of claim 11 wherein the processor morphs the user based on a stored image.

13. The apparatus of claim 12 further comprising:
storage, storing the stored image.

14. The apparatus of claim 13 wherein the stored image comprises an image of the user.

15. The apparatus of claim 11 wherein the context aware circuitry comprises one or more of:
a clock;
a calendar;
location circuitry
GPS circuitry;
a thermometer;
a radio;
caller identification circuitry;
speech recognition circuitry; and
short-range communication circuitry.

16. The apparatus of claim 11 wherein the context comprises one or more of:
a time of day;
a time of year;
a location;
a temperature;
localized weather information;
country of origin of caller;
who is speaking;
what devices are near; and
a caller identification.

17. The apparatus of claim 11 wherein the processor determines a morphing technique by determining an image associated with the context.

18. The apparatus of claim 17 wherein the image comprises a picture of the user.

19. The apparatus of claim of claim 11 wherein processor morphs the user by one or more of the following techniques:
morphing clothes onto the user;
morphing the user into a particular background;
morphing a particular color of clothes onto the user;
morphing makeup onto the user;
morphing clothes for a particular season onto the user;
morphing a particular emotional state onto the user;
morphing a particular skin color onto the user; and
morphing a head cover onto the user.
